(19) United States
(12) Patent Application Publication
(10) Pub. No.: US 2026/0126095 A1
(43) Pub. Date: May 7, 2026

(54) Damper System

(71) Applicant: Kyb Europe GmbH, Sucursal En Navarra, Ororbia (ES)

(72) Inventors: Javier Lizarraga Senar, Ororbia (ES); Jorge Trobajo San Martin, Ororbia (ES)

(21) Appl. No.: 19/379,841

(22) Filed: Nov. 5, 2025

(30) Foreign Application Priority Data
Nov. 6, 2024 (ES) P202430915

(51) Int. Cl. F16F 9/346

(52) U.S. Cl. CPC F16F 9/346; F16F 2222/12; F16F 2230/06

(57) ABSTRACT

A damper system including an outer tube, an inner tube located inside the outer tube and an intermediate tube located between the outer tube and the inner tube, including an intermediate chamber located between the intermediate tube and the inner tube. The damper system includes a separator element, fitted between the intermediate tube and the inner tube, which is configured to restrict or limit the inlet of the damping fluid from the intermediate chamber into the compression solenoid valve, and to channel the damping fluid from said intermediate chamber into the traction solenoid valve, as well as to restrict the inlet of the damping fluid from the intermediate chamber to the traction solenoid valve and to channel the damping fluid from said intermediate chamber to the compression solenoid valve.

### CROSS-REFERENCE TO RELATED APPLICATION

This application claims priority to Spanish Patent Application No. P202430915 filed November 6, 2024, the disclosure of which is hereby incorporated by reference in its entirety.

### BACKGROUND OF THE INVENTION

### FIELD OF THE INVENTION

The invention consists of a system capable of dividing the space or cavity created between two hydraulic cylinders into two hydraulically separated spaces or areas, restricting the passage of the hydraulic damping fluid while allowing the gas dissolved therein to discharge, and independently of the position of the inlet/outlet holes of the hydraulic connections that connect each of these two spaces to the outside.

The invention falls within the technical field of hydraulically operated devices, in particular hydraulic dampers for vehicles, such as those used in automobiles.

### DESCRIPTION OF RELATED ART

A damper is a device intended for attenuating the oscillations of the suspension in an automobile by means of dissipating kinetic energy until said automobile recovers the equilibrium position thereof. In this way, the damper has a decisive influence on both the stability and comfort of the vehicle. In fact, the adjustment of the hydraulic load that it generates represents a compromise between both factors:

Stability, dynamic control of the vehicle is performed at low extension or compression speeds of the suspension and low oscillation frequencies, corresponding to the natural frequency of the sprung mass (cabin), which is typically in the range of 1-1.5 Hz for passenger cars. In this operating regimen, a high level of damping, i.e., high hydraulic loads, is required.

Comfort, control is mainly related to medium and high extension and compression speeds of the suspension which occur at medium or high oscillation frequencies. The reference frequency is the natural frequency of the unsprung mass (wheel suspension), which is typically in the range of 8-15 Hz for passenger cars. A higher degree of comfort is subject to a reduced level of damping, which allows uncoupling the movement of the wheels from the oscillations of the chassis. Therefore, it is desirable for the damper to be able to adjust the load level thereof to the characteristics of the oscillations it must attenuate.

Electronic dampers use solenoid valves to control the load level of the damper to match the oscillations to be damped. They also use an intermediate tube concentric with the inner tube to hydraulically connect the working chamber with the solenoid valve.

When the electronic damper comprises two control solenoid valves, one to control compression movements and one for extension movements, the solenoid valves are normally located at different heights in the damper body and two separate intermediate tubes separated by O-rings are used.

This arrangement takes up a certain amount of space that is not always available in the vehicle due to the elements of the suspension system, making it necessary to locate the solenoid valves in other positions that are not possible with current designs due to the limitations caused by the damper components.

Documents WO2022112185 and US20230213080 disclose possible solutions for locating the valves in other positions than the usual one, both focussing on an arrangement of the solenoid valves at the same height and at 180° to each other.

For example, document WO2022112185 discloses, in a general manner, this type of damper which introduces two possible solutions: dividing the intermediate tube in two, with a sealing element therebetween, which divides the space between the intermediate tube and the inner tube into two hydraulically independent spaces; using an intermediate tube to connect the expansion chamber with the expansion solenoid valve and connecting the compression solenoid valve with the compression chamber through the inner tube.

Moreover, document US20230213080 describes in much more detail this type of damper which introduces a solution using an inclined elliptical sealing element located between the intermediate tube and the inner tube. The description and images in the document focus on damper configurations with the solenoid valves positioned at the same height and at 180° to each other, although no specific configuration is specified. While this solution allows for different damper configurations, it is a difficult solution to implement.

Moreover, the design in US20230213080 has two main drawbacks or difficulties. It is a difficult system to manufacture and assemble, as first of all, the gasket support rings have to be rigidly attached to the intermediate tube. The document does not specify exactly how to do this, but it is proposed to weld the support rings to the intermediate tube, which is a complex process for two reasons: on the one hand, it is necessary to position the support rings inside the tube in a specific position and with a small tolerance and, moreover, the risk of deformations derived from the welding process, which may cause difficulties when inserting the inner tube, which is a precision element that cannot be deformed as it is the tube through which the piston of the damper slides.

Before inserting the inner tube, the elliptical joint must be positioned in the inclined pocket created by the support rings. This type of gasket is not standard and is not widely used in the industry. The gasket assembly operation is a complex operation due to the inclined position, which makes the design of the assembly tooling difficult, and because it is located inside the tube at a certain distance from the edge thereof, which makes the access of said assembly tooling difficult. Once the gasket is mounted inside the intermediate tube with the support rings, the inner tube has to be inserted, with a high risk of pinching and cutting the gasket, or even removing it from the casing, because when inserting the tube there is no symmetrical force on the gasket to keep it inside the casing.

Another drawback of the proposed solution is the use of leak-proof seals, using rubber gaskets that prevent the passage of oil, but also do not allow the passage of gas that dissolves in the oil during the operation of the damper. In conventional dampers, where metal-to-metal seals are used that are not perfectly leak-proof, this gas escapes through these seals and returns to the expansion chamber of the damper. However, in electronic dampers comprising one or two intermediate tubes sealed with rubber gaskets, this gas accumulates in the upper portion of both the traction intermediate chamber and the compression intermediate chamber next to the rubber gasket. This creates a gas chamber within the working chambers of the damper that can be compressed under pressure, which is not the case with incompressible oil only. This situation means that, when the damper operates under these conditions, there is a delay in the generation of force due to the compression of the accumulated gas and therefore a malfunction of the damper.

This effect is well known in the industry and is the main difference between monotube and twin tube dampers. Whereas in monotube dampers the gas is isolated in an independent chamber with a hermetic seal (usually using O-rings with floating pistons), in twin-tube dampers there is no physical separation between the damper oil and the gas.

The management of gas dissolved in the oil in twin-tube dampers is one of the major challenges in this industry and there are solutions to eliminate or mitigate it, such as flat metal-to-metal seals that are not leak-proof. Another clear example is implemented in single-valve electronic dampers, which use a single intermediate tube with a rubber seal at the upper portion. In this case, the intermediate chamber is connected to the inner traction chamber in the upper area, and from there the accumulated gas is discharged into the expansion chamber through the clearance between the rod and the guide that allows the gas to pass through and greatly restricts oil flow.

The present invention consists of a damper system that can have two different solenoid valves, arranged transversally, at intermediate heights, capable of removing the gas dissolved in the damping fluid, avoiding its accumulation in the working chambers of the damper, such as the traction and compression chambers, maintaining two hydraulically differentiated spaces that communicate said chambers with their corresponding solenoid valve.

The described configuration facilitates the assembly of the damper system components and is easy to implement in existing damping systems.

### SUMMARY OF THE INVENTION

The invention consists of a damper system, as defined in the background, comprising an outer tube, an inner tube, located inside the outer tube, and an intermediate tube, located between the outer tube and the inner tube; wherein the inner tube, the outer tube and the intermediate tube are straight, and are oriented in a longitudinal direction. Preferably, as usual, said tubes are all cylindrical and concentric, so that the pressure distribution therein is regular.

The damper system also comprises a rod configured to be moved in a straight longitudinal direction relative to the outer tube, between two ends, and a piston connected to a first end portion of the rod, movable in the longitudinal direction along an inside of the inner tube, between a first traction end and a second compressive end. That is to say, like the dampers in the state of the art, where the rod can be connected at one end to the suspended mass of a vehicle, and the other end is connected to the piston, which slides inside the damper.

Both the arrangement of the tubes and the piston define the chambers of the damper system. On the one hand, said system comprises a traction chamber located inside the inner tube between the piston and the first traction end of said inner tube and a compression chamber located inside the inner tube between the piston and the second compression end of said inner tube. In other words, the piston delimits the working chambers of the damper within the inner tube and its movement generates the damping force of the vehicle's suspension. Since the piston is a sliding element, as is normal, the gap between the traction chamber and the compression chamber is not completely sealed, but allows a small amount of damping fluid to pass therebetween.

Moreover, the damper system also comprises an expansion chamber located between the outer tube and the intermediate tube, and an intermediate chamber located between the intermediate tube and the inner tube.

Obviously, the damper system also comprises a damping fluid, which is normally oil, since oil comprises characteristics suitable for use in these systems, being configured to flow between the traction, compression, expansion and intermediate chambers of the damper system, as well as through the solenoid valves, to allow the piston movement to be dampened.

The damper system also comprises a gas, with a certain pressure, which is located, together with a portion of the damping fluid, in the expansion chamber, with no physical separation between the gas and the damping fluid. The function of this expansion chamber is to provide damping fluid to the compression chamber when the rod performs an expansion movement with respect to the tubes, as well as to provide damping fluid to the traction chamber and receive it from the compression chamber, when the rod performs a compression movement.

To regulate the damping loads, in order to adjust the stability and comfort indicated in the background, the damper system comprises a compression solenoid valve, connected to a first section which is located at an intermediate position along of the outer tube, and is preferably oriented in a first transverse or substantially transverse direction, configured to control a first flow of damping fluid between the intermediate chamber and the expansion chamber; and a traction solenoid valve, connected to a second section of the outer tube, also preferably oriented in a second transverse or substantially transverse direction, configured to control a second flow of damping fluid between the intermediate chamber and the expansion chamber. In both cases, the damping fluid in the intermediate chamber comes from the damping fluid inside the inner tube, either in the traction chamber, which is directed to the intermediate chamber and from there to the traction solenoid valve, when the rod performs an expansion movement with respect to the tubes, or in the compression chamber, which is directed to the intermediate chamber and from there to the compression solenoid valve, when the rod performs a compression movement.

To control the passage of the damping fluid, both solenoid valves are connected to holes in the outer tube and the intermediate tube, in order to have access to the expansion chamber and the intermediate chamber.

In the damper system, the rod is configured, on the one hand, to move in a direction of extension, with respect to the outer tube, moving the piston integrally with the rod. This piston pushes the damping fluid located in the traction chamber into the intermediate chamber through at least one upper through hole in the inner tube, which links the traction chamber with the intermediate chamber. Moreover, the rod is also configured to be moved in a compression direction with respect to the outer tube, opposite to the extension direction, moving the piston integrally with the rod, where said piston pushes the damping fluid located in the compression chamber towards the intermediate chamber, through at least one lower through hole of the inner tube that connects the compression chamber with the intermediate chamber.

What differentiates the claimed damper system from those existing in the state of the art is that this system comprises a dividing, intermediate element, fitted between the intermediate tube and the inner tube, dividing the intermediate chamber into a lower intermediate chamber and an upper intermediate chamber. Said separator element is configured to restrict, or limit, the inlet of the damping fluid from the intermediate chamber into the compression solenoid valve, and to channel the damping fluid from said intermediate chamber into the traction solenoid valve, when the rod performs a longitudinal compression movement. Similarly, the separator element is configured to restrict or limit the inlet of the damping fluid from the intermediate chamber, coming from the compression chamber, into the traction solenoid valve, and to channel the damping fluid into the compression solenoid valve, when the rod performs a longitudinal compression movement.

The terms ‘restrict’ or ‘limit’ are used because the separator element is not completely leak-proof, as it may allow a fluid (liquid or gas) to pass through the tight fitting.

Preferably, this intermediate separator element is based on the hydraulic labyrinth sealing concept. Between the intermediate tube and the inner tube, a hydraulic space is created to direct the hydraulic fluid from the working chambers (traction or compression) to the corresponding solenoid valve. For this purpose it is necessary to divide the space between the inner tube and the intermediate tube into two hydraulic spaces that maintain the necessary pressure difference between the traction chamber and the compression chamber. This division of the space between the intermediate tube and the inner tube into two intermediate chambers is achieved by means of the intermediate separator element which is placed between the two tubes limiting the passage of damping fluid, creating an upper intermediate chamber and a lower intermediate chamber.

A labyrinth seal consists of a set of grooves or chambers that fit around an axle so that the damping fluid must travel a long and difficult path in order to escape. In other words, it is not an airtight or leak-proof seal, as such. It is a widely used concept, for example in the pistons of combustion engines, which use them to retain the oil and generate the high pressures during compression and combustion times.

In this way, the separator element restricts the passage of damping fluid, creating a labyrinth both on its outer surface with the inner surface of the intermediate tube, and on its inner surface with the outer surface of the inner tube, generating a pressure difference between the two intermediate chambers generated. In one embodiment detailed below, to create this hydraulic labyrinth, the intermediate element includes two or more ribs on its outer and inner surface.

In one embodiment, the separator element is fitted between the intermediate tube and the inner tube, comprises a preferably cylindrical duct shape, with a cross-section equal to the cross-section of the intermediate chamber. Duct-shaped means that it is similar to a tube as defined, straight and hollow on the inside. The separator element comprises a first window consisting of a side opening connected to a first open end of said duct, and a second window consisting of an opening connected to a second end of the duct. The first window, together with a first through intermediate hole of the intermediate tube, comprises a liquid passageway between the intermediate chamber and the traction solenoid valve, and the second window, together with a second through intermediate hole of the intermediate tube, comprises a damping liquid passageway between the intermediate chamber and the compression solenoid valve.

Thus, when the damper starts an extension movement, the damping fluid in the traction chamber (extension or upper chamber) is moved by the piston into the upper intermediate chamber through at least one upper hole of the inner tube. In turn, the damping fluid already present in said upper intermediate chamber is moved and flows through the free space created by the first window of the separator element until it reaches the first intermediate hole of the intermediate tube, which is hydraulically connected to the traction solenoid valve, since in this free space there is less resistance to the passage of the damping fluid than there is to flow between the walls of the inner tube and the intermediate tube with the separator element, preventing the damping fluid from flowing towards the compression solenoid valve.

Moreover, when the damper system initiates a compression movement, the damping fluid in the compression chamber (lower chamber) is moved and comes into the lower intermediate chamber, through at least one lower hole of the inner tube. In turn, the compression fluid present in said lower intermediate chamber is moved, flowing through the free space generated by the second window of the separator element, until it reaches the second intermediate hole of the intermediate tube, which is hydraulically connected to the compression solenoid valve, since the free space generated by the second window exerts a lower resistance to the passage of the liquid than that generated to go towards the traction solenoid valve.

In one embodiment, the separator element comprises:

- a cylindrical outer surface, in contact with the intermediate tube, comprising two or more outer ribs, spaced by an outer groove, where a maximum height of said two or more outer ribs comprises a tight junction, with the intermediate tube, with a clearance smaller than a clearance between the outer groove and said intermediate tube; and

- a cylindrical inner surface, in contact with the inner tube, comprising two or more inner ribs, spaced by an inner groove, where a maximum height of said two or more inner ribs comprises a tight junction with the inner tube, with a clearance smaller than a clearance between the inner groove and said inner tube.

This means that between the ribs of the separator element and the tubes there is a small clearance which generates a high resistance to the passage of the damping fluid creating a pressure drop, while the clearance is larger in the grooves, thus creating a space which the damping fluid must fill before flowing through the clearance between the next rib and the tubes, where the resistance to the passage of a fluid is higher. In this way, the hydraulic labyrinth sealing concept mentioned above is created.

The ribs are defined such that the clearance with the inner and intermediate tubes is reduced in the area of maximum rib height such that a narrowing of the oil passage section is generated in this area. This generates a pressure drop that is proportional to the height and length of the nerve.

The tight junction between the outer and inner ribs, respectively, with the intermediate tube and the inner tube is configured:

- to limit the passage of the damping fluid in said tight junction between the lower intermediate chamber and the upper intermediate chamber by directing the damping fluid through the windows to the solenoid valves when a longitudinal movement of the piston is generated, and

- to channel a gas accumulated in the lower intermediate chamber into the expansion chamber (through the upper seal of the intermediate tube).

In other words, the configuration of the ribs with the grooves comprises a labyrinth seal configured to channel a controlled passage of gas through the intermediate chamber (between the lower intermediate chamber and the upper intermediate chamber), into the expansion chamber, but which impedes the passage of the damping fluid, creating a permeable tight junction. Thus, dissolved gas in the compression chamber of the damper is prevented from being trapped and accumulating in the upper portion of the lower intermediate chamber. By avoiding this gas accumulation, delays in force generation due to compression of the accumulated gas are avoided, and malfunctioning of the damper is prevented.

In one embodiment, it may be the case that only one of the two surfaces, inner or outer, of the separator element may have defined ribs to allow the gas generated in the tension and compression chambers to pass through. The other surface, exterior or interior, could be smooth, without ribs. Thus, the separator element would have an outer surface and an inner surface, where at least one of said surfaces has ribs spaced by a groove, where the maximum height of said ribs comprises a tight junction with the adjoining tube (either the inner or intermediate tube) with a clearance smaller than a clearance between the groove and said tube. The tight junction between the ribs and the tube would limit the passage of the damping fluid in said tight junction and channel a gas to pass through.

Depending on the pressure difference between the two intermediate chambers defined by the separator element, said separator element may comprise more or less ribs to limit or allow the passage of the damping fluid. In addition, the ribs may have different geometry and different clearance between them and the tubes, resulting in a progressive pressure drop between the upper and lower intermediate chambers.

For example, in one embodiment, the clearance between the maximum height of one of the outer ribs with the intermediate tube may be different from the clearance of the maximum height of another of the outer ribs with the intermediate tube. Similarly, in a compatible embodiment, the clearance between the maximum height of one of the inner ribs with the inner tube may be different from the clearance between the maximum height of one of the other inner ribs with the inner tube. This means that not all ribs have to be identical, nor the fit with the tubes, inner or intermediate, must be identical, as it depends on the required pressure drop.

In one embodiment, the inner ribs and outer ribs border the first window and the second window of the separator element. The ribs that generate the labyrinth that restricts the passage of oil must be positioned bordering these windows, so that the damping fluid must travel along the path generated by the labyrinth in order to flow from one window to the other.

In one embodiment, at least one of the outer ribs and/or one of the inner ribs comprises a rectangular or triangular cross-section. Thus, the ribs can have different designs, depending on the required pressure drop.

In one embodiment, the damper system comprises a valve support connected to a lower end of the outer tube. This support can also be connected to the inner tube and the intermediate tube.

In one embodiment, the damper system comprises a rod guide connected to an upper end portion of the outer tube. This guide can also be connected to the inner tube and the intermediate tube.

In one embodiment, the separator element comprises a protruding localiser element adjustable to a notch of the inner tube and/or the intermediate tube, wherein said protruding element is preferably located at a lower end portion or at an upper end portion of the separator element, and the notch is preferably located at a lower end portion or at an upper end portion of the inner tube and/or the intermediate tube. By means of said protruding element, the assembly or mounting of the separator element inside the tubes is facilitated, ensuring a position that requires a high degree of precision for correct functioning of the components. The notch may be a through or blind opening, sufficient to secure the assembly of the separator element with the tubes.

In some embodiments where, depending on the design requirements, the solenoid valves are located at a certain distance away from the lower portion of the damper system, a portion of the separator element must be elongated with respect to the windows, namely the wall on which the protruding localiser element is located, in order to be able to position it at the lowest or highest portion of the damper. This protruding localiser element can have different design and position depending on the configuration of the damper.

In one embodiment, the protruding localiser element of the separator element is located between the intermediate tube and the valve support, on a lower portion of the separator element. In this embodiment, the protruding element can be fitted between two elements of the damper system, allowing a precise fit, avoiding the need for a notch or opening in at intermediate position along of the intermediate tube.

In one embodiment, the separator element comprises a cylindrical strip between the valve support and the intermediate tube, by way of a gasket, which delimits the lower intermediate chamber at a lower end portion. This cylindrical strip can act as a protruding localiser element.

In one embodiment, the intermediate tube comprises two separate portions connected by a tight junction by means of the separator element, e.g. by two concentric circular grooves. In other words, in this embodiment, the intermediate tube is comprised of two separate tubes, with the separator element being used as a connector between the two tubes (the separator element still fulfilling its functions of allowing gas leakage and separating the chamber generated between the two parts of the intermediate tube and the inner tube).

Also, in this embodiment, the protruding localiser element is not required, since the position of the separator element is a function of the lengths of the intermediate tubes.

In one embodiment, the traction solenoid valve and the compression solenoid valve are at the same height and transverse direction with respect to the outer tube. In this embodiment, it could be that the windows of the separator element are at the same height, but in different transverse directions.

In another embodiment, the traction solenoid valve and the compression solenoid valve are located at different heights and transverse directions with respect to the outer tube.

In other words, the separator element is compatible with the solenoid valves being at the same height or at different heights with respect to the tubes.

In one embodiment, the traction solenoid valve and the compression solenoid valve are oriented at an angle comprised between 0° and 180°, with respect to a transverse plane perpendicular to the longitudinal direction of the tubes. This orientation depends on whether the solenoid valves are at the same or different heights. That is, if they are at the same height, they should be at a sufficiently wide angle so that they do not step on each other. Similarly, if they are at different heights, they could be inclined at 0° to each other, which would mean that the windows of the separator element would be in the same transverse direction, but at a different height.

### BRIEF DESCRIPTION OF THE DRAWINGS

The terms Fig., Figs., Figure, and Figures are used interchangeably in the specification to refer to the corresponding figures in the drawings.

To complete the description, and for the purpose of helping to make the features of the invention more readily understandable, this specification is accompanied by a set of drawings constituting an integral part of the same, wherein by way of illustration and not limitation the following has been represented:

FIG. 1A is a side perspective view of the damper system with the solenoid valves arranged at 90° and at different heights with respect to the outer tube.

FIG. 1B is a plan view of the damper system in FIG. 1A.

FIG. 2A is a side perspective view of the damper system with the solenoid valves arranged at 180° and at the same height from each other with respect to the outer tube.

FIG. 2B is a plan view of the damper system in FIG. 2A.

FIG. 3A is a side perspective view of the damper system with the solenoid valves arranged at 100° and at the same height between them with respect to the outer tube.

FIG. 3B is a plan view of the damper system in FIG. 3A.

FIGS. 4A and 4B are elevation views, cut in half, of the damper system of the FIGS. 1A and 1B, by the cross section of the compression solenoid valve and by the cross section of the traction solenoid valve, showing the internal components of the damper system, as well as the arrangement of the separator element inside the intermediate chamber.

FIGS. 5A and 5B are detailed views of the cut-away elevations shown in FIGS. 4A and 4B, where the arrangement of the separator element inside the intermediate chamber with respect to the tubes and the solenoid valves can be clearly seen.

FIG. 6A is a cutaway profile view of a portion of the separator element in which the outer and inner ribs are located, separated by the respective grooves. This particular figure shows an embodiment in which the separator element comprises four ribs, generating two inner and two outer barriers, with constant clearance, and an elongated rectangular cross-section.

FIG. 6B is a profile view, similar to that shown in FIG. 6A, where the separator element comprises four ribs, generating two inner and two outer barriers, with constant clearance, and triangular cross section or shape.

FIG. 6C is a profile view, similar to that shown in FIG. 6A, where the separator element comprises a configuration of five ribs, generating two inner and three outer barriers, with a variable clearance between said ribs, and a rectangular and elongated cross section.

FIG. 6D is a profile view, similar to that shown in FIG. 6A, where the separator element comprises a six-rib configuration, generating three inner and three outer triangular barriers (one rectangular and two triangular).

FIGS. 7A-7E are five perspective views, elevation and cutaway elevation and cutaway profile of the same separator element, showing the inner and outer rectangular ribs, the outer and inner grooves, the protruding localiser element and the windows of the separator element.

FIGS. 8A and 8B are elevation views, cut in half, of the damper system represented in FIGS. 3A and 3B, by the cross section of the compression solenoid valve and by the cross section of the traction solenoid valve, showing the internal components of the damper system, as well as the arrangement of the separator element inside the intermediate chamber. In these figures it can be seen that the solenoid valves are slightly away from the lower end of the tubes, so that the separator element comprises an elongated wall where the protruding element is assembled to a notch, in the form of a through opening of the inner tube, also located at a lower end of the inner tube.

FIGS. 9A and 9B are two perspective views of the separator element of the damper system shown in FIGS. 8A and 8B, showing the elongated wall with the protruding element at the lower end portion.

FIG. 10A is an elevation view, cut in half, at the height of the compression solenoid valve, in detail, as shown in FIG. 5A, showing the protruding localiser element of the separator element, inserted in a through notch of an intermediate tube.

FIG. 10B is an elevation view, cut in half, at the height of the compression solenoid valve, in detail, as shown in FIG. 10A, where the separator element comprises a cylindrical strip housed between the valve support and the intermediate tube that delimits the lower intermediate chamber by an end lower portion.

FIG. 10C is an elevation view, cut in half, at the height of the traction and compression solenoid valves, in detail, where the intermediate tube comprises two separate portions connected by a tight junction by means of the separator element.

### List of elements shown in the figures:

1.- Outer tube

2.- Intermediate tube

3.- Inner tube

4.- Rod

5.- Piston

6.- Separator element

7.- Compression solenoid valve

8.- Traction solenoid valve

9.- Valve support

10.- Traction chamber

11.- Compression chamber

12.- Expansion chamber

13.- Intermediate chamber

20.- Upper hole

21.- Lower hole

22.- First intermediate hole

23.- Second intermediate hole

24.- First window

25.- Second window

26.- Outer rib

27.- Outer groove

28.- Inner rib

29.- Inner groove

30.- Protruding element

31.- Notch

32.- Cylindrical strip

### DESCRIPTION OF THE INVENTION

The present invention consists of a damper system or damper with specific design features, which can be seen in FIGS. 1A-3A, 1B-3B.

These figures show different damper systems comprising a traction solenoid valve (8) and a compression solenoid valve (7) both located in different parts or intermediate sections of the outer tube (1) of the damper system. As can be seen in these FIGS. 1A-3A and 1B-3B, the solenoid valves (7, 8) are oriented in directions transverse to the longitudinal direction, determined by the tubes (1, 2, 3) comprised in the damper system. More specifically, the solenoid valves (7, 8) are each located on the inside of a corresponding tube oriented in a transverse direction. This arrangement is due to the different design needs that damper systems may require, for example, for use in vehicles with limited space requirements where the solenoid valves cannot be positioned in line with each other, as is more usual.

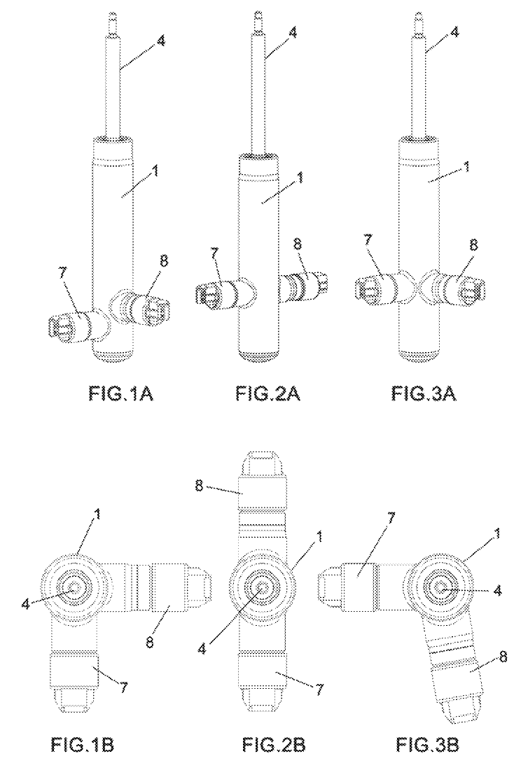

FIGS. 1A and 1B, for example, show a damper system where the two solenoid valves (7, 8) are at different heights and oriented at 90° relative to the outer tube (1). FIGS. 2A and 2B show a damper system where the two solenoid valves (7, 8) are at the same height, and oriented at 180° relative to the outer tube (1), and FIGS. 3A and 3B show a damper system where the two solenoid valves (7, 8) are at the same height, and oriented at 100° relative to the outer tube (1). This means that, in this embodiment, different arrangements of the solenoid valves (7, 8) are enabled, with the valves being located at different heights and facing different orientations.

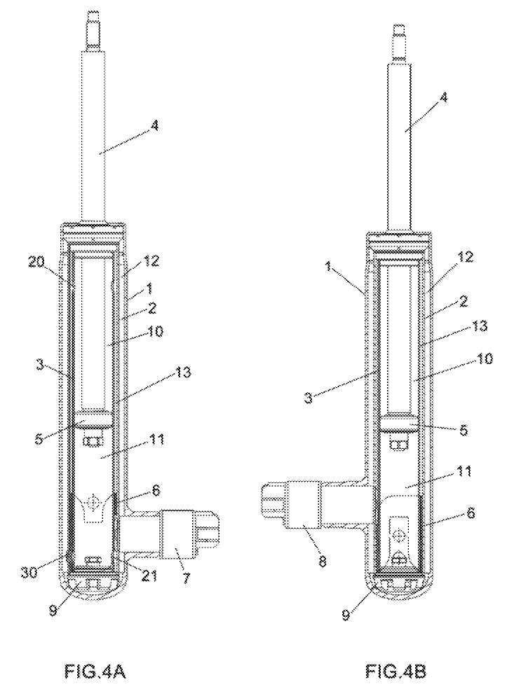

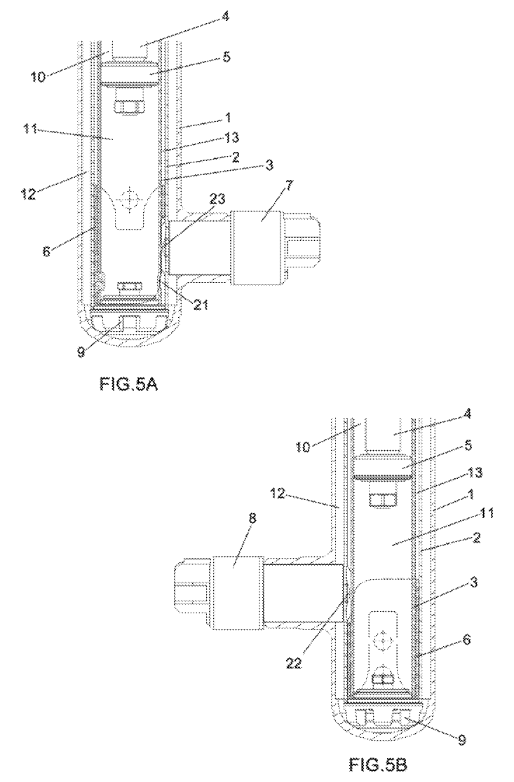

FIGS. 4A-4B and 5A-5B show almost all the components comprised in the damper system, as well as the arrangement therebetween. Firstly, three tubes (1, 2 and 3) can be seen: an outer tube (1), an inner tube (3) located inside the outer tube (1) and an intermediate tube (2), located between the outer tube (1) and the inner tube (3). All these tubes (1, 2 and 3) are straight, cylindrical, hollow, concentrically arranged, oriented in a longitudinal direction.

Like the damper systems described above, the present damper system also comprises a rod (4) comprising an upper end portion connectable to an external element, such as the body of a vehicle to be damped, and a lower end portion connected to a piston (5) which is slidably movable in the longitudinal direction along the inside of the inner tube (3).

At one end of the upper portion of the outer tube (1), the damper system comprises a retainer and a guide to limit the movement of the rod (4) to the longitudinal direction, and to prevent the outflow of the damping fluid located inside the tubes (1, 2, 3). At the lower portion of the outer tube (1), the damper system comprises a valve support (9) connecting the tubes (1, 2, 3) and configuring the damping fluid passage therebetween.

As can be seen in the figures, especially in FIGS. 5A and 5B, between the tubes (1, 2, 3) of the damper system, there are chambers through which the damping fluid flows.

More specifically, the damper system comprises a traction chamber (10) located inside the inner tube (3), between the piston (5) and the first, upper end of said inner tube (3), also called the traction end; a compression chamber (11) located inside the inner tube (3) between the piston (5) and the second, lower end of the inner tube (3), also called the compression end; an expansion chamber (12) located between the outer tube (1) and the intermediate tube (2); and an intermediate chamber (13) located between the intermediate tube (2) and the inner tube (3).

The functioning of the damper system described is similar to those existing in the state of the art, such that the upper end portion of the rod can be connected to a first external element, such as a portion of a vehicle body, while the lower end portion of the outer tube can be connected to a second external element, such as a wheel in contact with the road, to dampen the movement of the wheel in the body. In this configuration, the rod (4) can be moved in an extension direction relative to the outer tube (1), moving the piston (5) in the same manner, integrally with the rod (4), so that said piston (5) pushes the damping fluid located in the traction chamber (10) towards the intermediate chamber (13), through one or more upper through holes (20) of the inner tube (3). Moreover, when the rod (4) is moved in a compression direction with respect to the outer tube (1), opposite to the extension direction, it moves the piston (5) also integrally with the rod (4), pushing the damping liquid located in the compression chamber (11) towards the intermediate chamber (13), through one or more lower through holes (21) of the inner tube (3).

The main difference of the damper system described with respect to those defined in the preceding paragraphs is that the damper system comprises a separator element (6) located in the intermediate chamber (13), tightly positioned between the inner tube (3) and the intermediate tube (2), dividing said intermediate chamber (13) into an upper intermediate chamber and a lower intermediate chamber.

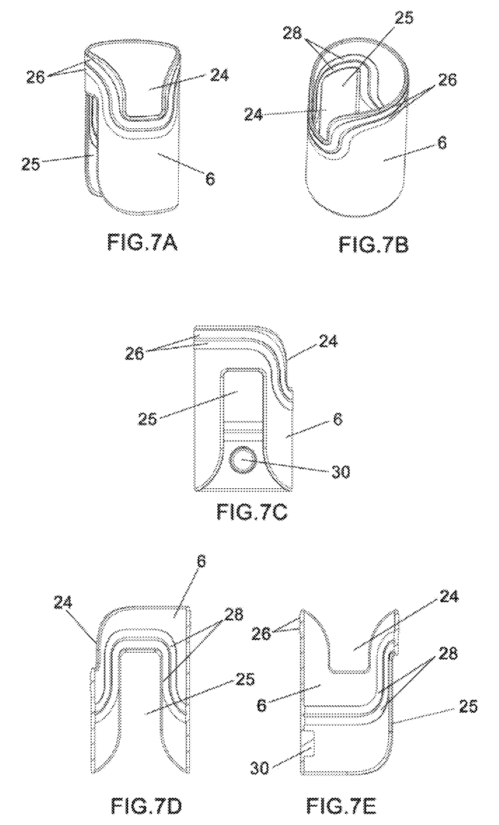

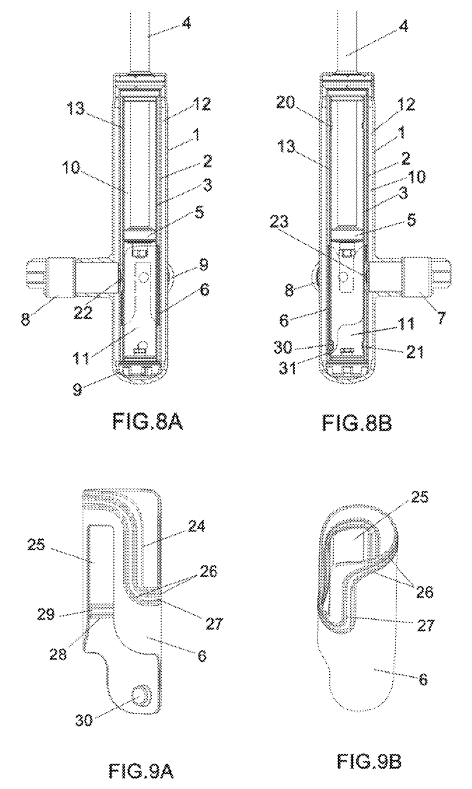

This separator element (6) may comprise different shapes, configurations or arrangements, such as, for example, those shown in FIGS. 7A-7E as well as FIGS. 9A and 9B. As can be seen in said figures, the separator element (6) comprises a cylindrical shape, with a cross-section similar in size to that of the intermediate chamber (13). It further comprises a first window (24) consisting of a side opening connected to a first open end of said duct, and a second window (25) consisting of an opening connected to a second end of the duct. The first window (24) together with a first through intermediate hole (22) of the intermediate tube (2) comprise a liquid passageway between the intermediate chamber (13) and the traction solenoid valve (8), and the second window (25) together with a second through intermediate hole (23) of the intermediate tube (2) comprises a damping liquid passageway between the intermediate chamber (13) and the compression solenoid valve (7).

It can also be seen in the above figures that the separator element (6) comprises ribs (26, 28) that allow a permeable fit with the inner tube (3) and the intermediate tube (2), which allows a small controlled passage of fluid. In particular, on a cylindrical outer surface, the separator element (6) comprises outer ribs (26), each pair of which is separated by an outer groove (27), where a maximum height of said outer ribs (26) comprises a tight junction with the intermediate tube (2), which is obviously smaller than the clearance between the outer groove (27) and said intermediate tube (2). Moreover, the cylindrical inner surface of the separator element (6) also comprises two or more inner ribs (28), spaced, each pair of them, by an inner groove (29), such that the maximum height of said inner ribs (28) comprises a tight junction with the inner tube (3), with a clearance smaller than the clearance between the inner groove (29) and the inner tube (3).

The figures also show that the inner ribs (28) and outer ribs (26) border the first window (24) and the second window (25) of the separator element (6), i.e. they cover the entire perimeter of the separator element (6) avoiding longitudinal grooves through which the damping fluid can escape.

From the design described above, two objectives of the separator element are defined. On the one hand, it aims to restrict or limit as much as possible the inlet of the damping fluid from the intermediate chamber (13), specifically from the upper intermediate chamber, towards the compression solenoid valve (7), channelling said damping fluid, coming from the traction chamber (10), towards the traction solenoid valve (8), when the rod (4) performs a longitudinal movement in the extension direction. Moreover, its purpose is to restrict or limit the inlet of the damping fluid from the intermediate chamber (13), specifically from the lower intermediate chamber, towards the traction solenoid valve (8), channelling said damping fluid, coming from the compression chamber (11), towards the compression solenoid valve (7), when the rod (4) performs a longitudinal compression movement.

This function of the separator element (6) is achieved thanks to the permeable tight junction between the outer (26) and inner ribs (28), respectively, with the intermediate tube (2) and the inner tube (3), as they allow the passage of the damping fluid to be limited, in said tight junction, between the lower intermediate chamber and the upper intermediate chamber, directing the damping fluid, through the windows (24, 25), towards the solenoid valves (7, 8), when a longitudinal movement of the piston (5) is generated. In other words, the hydraulic resistance to the passage of fluid between the ribs (26, 28) and the inner (3) and intermediate tubes (2) is greater than the hydraulic resistance between the windows (24, 25) of the separator element (6) and said tubes. Similarly, said resistance to the passage of fluid between the ribs (26, 28) is greater than the hydraulic resistance in the intermediate holes (22, 23), so that the damping fluid is channelled to the solenoid valves (7, 8).

Similarly, the clearances between the ribs (26, 28) and the tubes also allow the passage of a gas that accumulates in the lower intermediate chamber due to a gas dissolved in the damping fluid in the compression chamber (11) during the use of the damper, which is a way to solve a common problem in damping systems as defined in the background. That is, the separator element (6) is configured, with respect to the inner (3) and intermediate (2) tubes, to allow the gas generated during the use of the damper system to pass through, creating a permeable tight junction.

This configuration of the ribs (26, 28) is known as a labyrinth seal or hydraulic labyrinth seal, where the assembly is made up of a set of grooves or chambers that fit around an axis so that the damping fluid must travel a long and difficult path in order to escape, without the assembly being leak-proof or airtight, to allow gas to pass through, and to provide improved performance over that which is available when gas accumulates in the lower intermediate chamber.

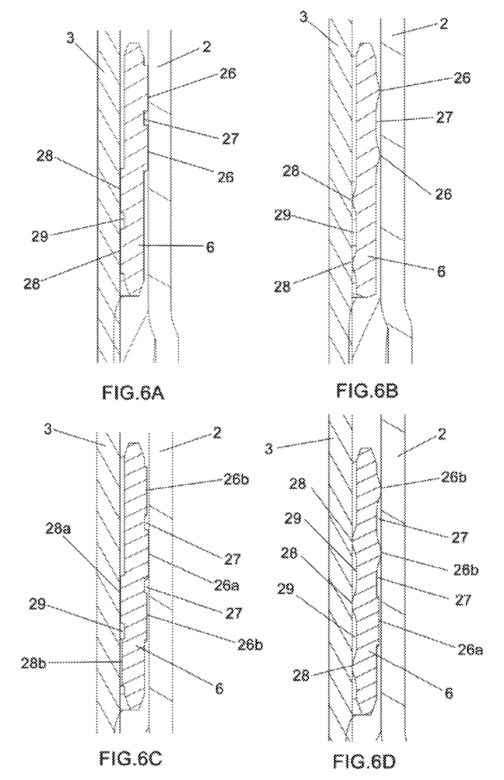

As can be seen in FIGS. 6A to 6D, the ribs (26, 28) may comprise different configurations. For example, FIG. 6A shows that the separator element comprises two rectangular inner ribs (28) and two rectangular outer ribs (26), creating two inner and two outer barriers, with a constant clearance. Moreover, in FIG. 6B, the separator element comprises four ribs, generating two inner and two outer barriers, with constant clearance, but with a triangular cross section or shape. The use or choice of one form or another will depend on the hydraulic resistance to the passage of the damping fluid to be achieved in said ribs. In FIG. 6C, the separator element comprises a five-rib configuration, generating two inner and three outer barriers, with a variable clearance between said ribs, and a rectangular and elongated cross section, while in FIG. 6D, the separator element (6) comprises a six-rib configuration, generating three inner and three outer triangular barriers (one rectangular and two triangular). In other words, it is not necessary that all the ribs are identical, nor that there is the same number of ribs on the inner surface as on the outer surface of the separator element (6), but it will depend on the load to be supported by the fit between said separator element (6) and the tubes.

FIGS. 7C, 7E as well as FIG. 9A show that the separator element (6) also comprises a protruding localiser element (30) adjustable to a notch (31) of the inner tube (3) or of the intermediate tube (2). All figures show that the protruding element (30) is located at the lower end portion of the separator element (6), just as the notch (31) is located at the lower end portion of the inner tube (3) or the intermediate tube (2), to prevent said assembly from interacting with other components of the damper, such as the piston (5).

The connection or assembly of the protruding element (30) with the notch (31) allows a precise attachment of the separator element (6), which in turn allows the parts of the separator element (6), such as the ribs (26, 28) as well as the windows (24, 25) to be correctly positioned with respect to the solenoid valves (7, 8).

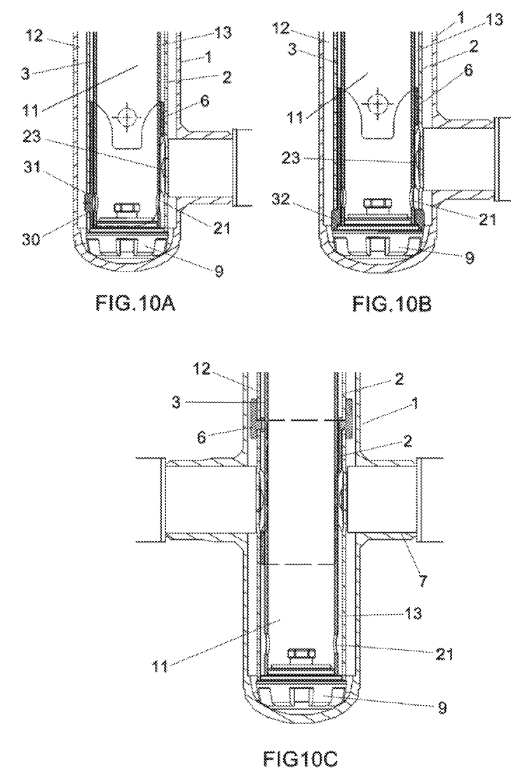

FIGS. 10B and 10C show other possible embodiments for positioning the separator element (6) in the correct position. For example, in the embodiment shown in FIG. 10B, the separator element (6) comprises a cylindrical strip (32) located between the valve support (9) and the intermediate tube (2), by way of a gasket, which delimits the lower intermediate chamber (13) at the lower end portion. This cylindrical strip (32) can act as a protruding localiser element.

In the embodiment shown in FIG. 10C, the intermediate tube (2) comprises two separate portions connected by a joint fitted by the separator element (6). In other words, in this embodiment, the intermediate tube (2) is comprised of two separate tubes, with the separator element (6) being used as a connector between the two tubes.

Also in this embodiment, the position of the separator element (6) is a function of the lengths of the intermediate tubes.

1. A damper system comprising:
an outer tube;
an inner tube located inside the outer tube;
an intermediate tube, located between the outer tube and the inner tube;
a rod configured to be moved in a straight longitudinal direction relative to the outer tube;
a piston attached to a first end portion of the rod, movable in the longitudinal direction along the inside of the inner tube, between a first traction end and a second compression end;
a traction chamber located inside the inner tube, between the piston and the first end of the inner tube;
a compression chamber located on an inside of the inner tube, between the piston and the second end of the inner tube;
an expansion chamber located between the outer tube and the intermediate tube;
an intermediate chamber located between the intermediate tube and the inner tube;
a damping fluid, configured to flow between the traction, compression, expansion and intermediate chambers of the damper system;
a compression solenoid valve, connected to a first section, located at an intermediate position along, of the outer tube, wherein said compression solenoid valve is preferably oriented in a first transverse direction, and is configured to control a first flow of damping fluid between the intermediate chamber and the expansion chamber;
a traction solenoid valve, connected to a second section, located at an intermediate position along, of the outer tube, wherein said traction solenoid valve is preferably oriented in a second transverse direction, and is configured to control a second flow of damping fluid between the intermediate chamber and the expansion chamber;
wherein the inner tube, the outer tube and the intermediate tube are straight, and are oriented in a longitudinal direction;
wherein the rod is configured to be moved in an extension direction, with respect to the outer tube, by moving the piston integrally with the rod, wherein said piston pushes the damping fluid located in the traction chamber towards the intermediate chamber, through at least one upper hole passing through the inner tube;
wherein the rod is configured to be moved in a compression direction with respect to the outer tube, opposite to the extension direction, by moving the piston integrally with the rod, wherein said piston pushes the damping fluid located in the compression chamber towards the intermediate chamber, through at least one lower hole through the inner tube;
wherein the damper system further comprises:
an intermediate separator element, fitted between the intermediate tube and the inner tube, dividing the intermediate chamber into a lower intermediate chamber and an upper intermediate chamber; wherein said separator element is configured to:
○ restrict the inlet of the damping fluid from the intermediate chamber to the compression solenoid valve, and channel the damping fluid from said intermediate chamber to the traction solenoid valve, when the rod performs a longitudinal movement in the extension direction; and
○ restrict the inlet of the damping fluid from the intermediate chamber to the traction solenoid valve, and channel the damping fluid from said intermediate chamber to the compression solenoid valve, when the rod performs a longitudinal compression movement.

2. The damper system according to claim 1, wherein the separator element is fitted between the intermediate tube and the inner tube, comprises a duct shape, having a cross-section equal to the cross-section of the intermediate chamber, comprising a first window consisting of a side opening connected to a first open end of said duct, and a second window consisting of an opening connected to a second end of the duct; wherein the first window together with a first through intermediate hole of the intermediate tube comprises a fluid passageway between the intermediate chamber and the traction solenoid valve, and wherein the second window together with a second through intermediate hole of the intermediate tube comprises a damping fluid passageway between the intermediate chamber and the compression solenoid valve.

3. The damper system according to claim 2, wherein the separator element comprises:
a cylindrical outer surface comprising two or more outer ribs spaced by an outer groove, wherein a maximum height of said two or more outer ribs comprise a tight junction, with the intermediate tube having a clearance smaller than a clearance between the outer groove and said intermediate tube; and
a cylindrical inner surface comprising two or more inner ribs spaced by an inner groove, wherein a maximum height of said two or more inner ribs comprise a tight junction with the inner tube, having a clearance smaller than a clearance between the inner groove and said inner tube; wherein the tight junction between the outer and inner ribs, respectively, with the intermediate tube and the inner tube is configured:
to limit the passage of the damping fluid in said tight junction between the lower intermediate chamber and the upper intermediate chamber by directing the damping fluid through the windows to the solenoid valves when a longitudinal movement of the piston is generated, and
to channel a passage of a gas accumulated in the lower intermediate chamber into the expansion chamber, during the use of the damper.

4. The damper system according to claim 3, wherein the inner ribs and the outer ribs border the first window and the second window of the separator element.

5. The damper system according to claim 3, wherein the clearance between the maximum height of one of the outer ribs with the intermediate tube is different from the clearance between the maximum height of another of the outer ribs with the intermediate tube.

6. The damper system according to claim 3, wherein the clearance between the maximum height of one of the inner ribs with the inner tube is different from the clearance between the maximum height of another of the inner ribs with the inner tube.

7. The damper system according to claim 3, wherein at least one of the outer ribs and/or one of the inner ribs comprises a rectangular or triangular cross-section.

8. The damper system according to claim 1, comprising a valve support connected to a lower end of the outer tube.

9. The damper system according to claim 1, wherein the separator element comprises a protruding localiser element, adjustable to a notch of the inner tube or the intermediate tube, wherein said protruding element is preferably located at a lower or upper end portion of the separator element, and the notch is preferably located at a lower or upper end portion of the inner tube or the intermediate tube.

10. The damper system according to claim 8, wherein the protruding localiser element of the separator element is located between the intermediate tube and the valve support, in a lower portion of the separator element.

11. The damper system according to claim 8, wherein the separator element comprises a cylindrical strip housed between the valve support and the intermediate tube that delimits the lower intermediate chamber at a lower end portion.

12. The damper system according to claim 1, wherein the intermediate tube comprises two separate parts connected by a tight junction by means of the separator element.

13. The damper system according to claim 1, wherein the traction solenoid valve and the compression solenoid valve are at the same height and in the same transverse direction with respect to the outer tube.

14. The damper system according to claim 1, wherein the traction solenoid valve and the compression solenoid valve are located at different heights with respect to the outer tube.

15. The damper system according to claim 1, wherein the traction solenoid valve and the compression solenoid valve are oriented at an angle comprised between 0° and 180° with respect to a transverse plane perpendicular to the longitudinal direction of the tubes.
